(19) United States
(12) Patent Application Publication
(10) Pub. No.: US 2006/0224596 A1
(43) Pub. Date: Oct. 5, 2006

(54) System and method for notification of acquired information

(76) Inventors: Colin Leonard Bird, Eastleigh (GB); John B. Ibbotson, Salisbury (GB); Ian M. Shore, Romsey (GB)

Correspondence Address: IBM CORPORATION;INTELLECTUAL PROPERTY LAW, 11400 BURNET ROAD, AUSTIN, TX, 78758, US

(21) Appl. No.: 11/372,328

(22) Filed: Mar. 9, 2006

(30) Foreign Application Priority Data
Mar. 31, 2005 (GB) 0506532.1

(51) Int. Cl. G06F 17/30

(52) U.S. Cl. 707/10

(57) ABSTRACT

A system (100) and method (200) for general notification of newly-acquired information by: subscribing (230) an indexing service (124; 128) to a broker (140) for a predetermined selection of information stored on an object server (110); and producing related information associated with the information stored on the object server, and publishing (220) the related information to the broker (140) for use in retrieval of the stored information from the object server. The related information preferably comprises metadata and tokens, and the indexing service the metadata for indexing and if the metadata is not relevant to its level of indexing uses the tokens to retrieve a copy of the related information for further analysis. This provides a combination of anonymous publish/subscribe technology to integrate otherwise centralised indexing and object storage, allowing content to be “pushed” to end user clients (130).

### FIELD OF THE INVENTION

This invention relates to indexing and searching in a distributed (e.g., Internet-based) system.

### BACKGROUND OF THE INVENTION

In the field of this invention it is known that storing newly-acquired information is a routine process, but unless appropriate steps are taken, a wider user community that wants to use that information can remain unaware of its existence. Existing methods rely on suitably structured queries to databases that might hold objects relevant to the information needs that prompted the query. The drawback is evident: no information is forthcoming unless a query is issued. These existing methods may be considered as ‘pull’ methods: interested parties have to “data mine” for information that might be of interest, by pulling it from a range of database sources. If the sources are primary, users typically employ a search engine, but indexing services that “enrich” the information provide a more effective approach to information discovery, and are likely also to be more efficient. The growth in the amount of information available online must inevitably lead to an increase in the availability of indexing services. These will typically comprise of a range of indexing servers distributed across a computer network.

An example of the need for an active method of information management/mining is described in the publication “Information grids: managing and mining semantic data in a grid infrastructure; open issues and application to geno-medical data”, Brunie et al, pp.509-515, Proc. 14th International Workshop on Database and Expert Systems Applications (DEXA '03), 2003.

In the publication “Distributed Indexing and Searching: A Big Picture” by Daigle and Mazzucato (available at website http://www.w3.org/Search/9605-Indexing-Workshop/Papers/Daigle@bunyip.html) it is suggested for indexing servers to be distributed. However, although this publication suggests that rather than allowing indexers to ‘pull’ the indexing data the server would be better served by making agreements with indexing services to which the data could be ‘pushed’, it offers no suggestions about how such “agreements” might be implemented.

A need therefore exists for a system and method for general notification of newly-acquired information wherein the abovementioned disadvantage(s) may be alleviated.

### STATEMENT OF INVENTION

In accordance with a first aspect of the present invention there is provided a system for general notification of newly-acquired information as claimed in claim 1.

In accordance with a second aspect of the present invention there is provided a method for general notification of newly-acquired information as claimed in claim 8.

### BRIEF DESCRIPTION OF THE DRAWING(S)

One system and method for general notification of newly-acquired information incorporating the present invention will now be described, by way of example only, with reference to the accompanying drawing(s), in which:

FIG. 1 shows a block-schematic diagrammatic illustration of the relationship between object servers, indexing services, and end user clients in an information indexing system incorporating the present invention; and

FIG. 2 shows a more detailed block-schematic diagrammatic illustration of the improved information indexing system of FIG. 1; and

FIG. 3 shows an illustration of the novel method followed in the system of FIG. 1 and FIG. 2.

### DESCRIPTION OF PREFERRED EMBODIMENT(S)

As will be explained in greater detail below, a novel system and method incorporating the present invention publishes to the wider community the fact that a fresh information object has been acquired and stored, rather than expecting members of the community to pull the information on their own initiative. For the purposes of this description, the term ‘wider community’ is used to mean both end users and indexing services that perform an enrichment role for newly stored information objects.

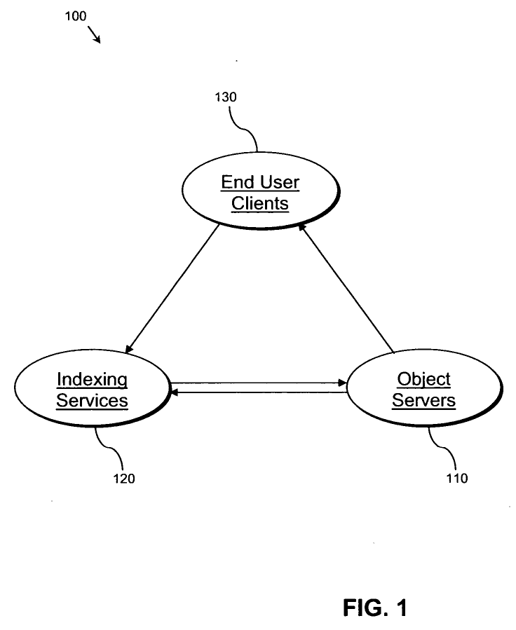

As illustrated in FIG. 1, the system environment 100 in which this novel method operates comprises: a set of distributed object servers 110, a set of distributed indexing services 120, and an indeterminate population of end user clients 130. Fresh information objects go first to the indexing server, which creates indexing metadata and then passes the information object to the object server for storage. The object server returns a token to the indexing server, that token enabling the object to be retrieved uniquely. As will be explained further below, the metadata includes elements that characterize the information content, together with tokens that enable the object to be retrieved uniquely.

In this architecture, there is a tight relationship between the three components 110, 120 and 130. Typically, the creation of new information objects within an Object Server 110 is managed by the Indexing Service 120. All objects are indexed before being stored on an appropriate Object Server 110 whose location is determined by the Indexing Service 120. There may be many Object Servers distributed throughout a network but typically there is a single Index Service that manages and provides access to the information objects. End User Clients 130 retrieve information objects by submitting a query to the Indexing Service 120 which returns a set of hits that include references to the information objects. A user then retrieves the information object by selecting the appropriate hit. In some cases (as in Content Management systems) the user's request for the object is validated by the Indexing Service before instructing an Object Server to return the information object to a user. In other indexing systems such as Google™ the hits include the URL (Uniform Resource Locator) of the appropriate page that the user accesses directly (though Internet search engines employ crawlers to assemble the indexes rather than the formal index/store process used in large content management systems).

Although it might be thought that known publication indexing services provided by third parties are the equivalent of this method's indexing servers, it must be understood that these known services essentially involve the amalgamation and remarketing of indexing information (typically a set of keywords) provided by the publishers of the original information. The novel method described herein is significantly more flexible and adds selectivity to the indexing process, as described below.

In this novel method, the Indexing Services receive metadata published by the Object Servers through a subscription service. The Indexing Services are then able to create entries into structured indexes that create enriched metadata for the information objects stored elsewhere. If necessary, the Indexing Services can use the tokens published by the Object Servers to retrieve an object for further indexing and analysis. It will be understood that the tokens are unique locators, for example URIs (Uniform Resource Indicators). However, an important attribute of the ‘triangle architecture’ of this embodiment is the access control afforded to the object servers. Clients route their requests through the indexing servers, which notify the relevant objects server to send the required information object (as identified by the token) to the clients (probably identified by an IP—Internet Protocol—address). It will further be understood that the metadata is of two kinds: (a) the classification information published by the object server to the broker, and (b) the indexing metadata created by the indexing servers. Both comply with the standard definition of metadata: “data about data”. The classification information might, for example, be a topic string, such as /news/sport/tennis/Wimbledon/final/winner or it might be a fragment of XML (extensible Markup Language) that conforms to a controlled classification vocabulary. The indexing metadata is likely to be a function of the indexing method employed. For example, for a picture it might comprise a set of feature vectors derived by computations performed on the image content.

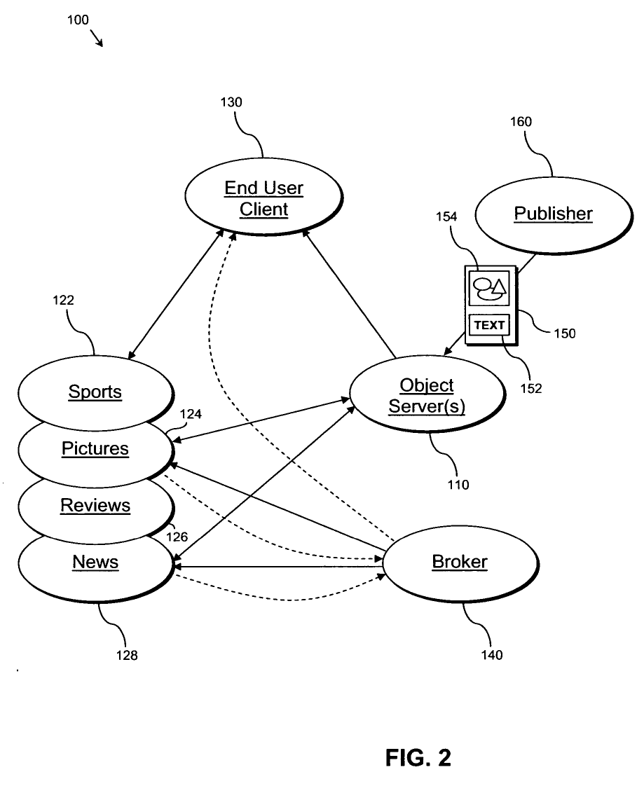

Referring now to FIG. 2, in comparison to the preceding high-level diagram of FIG. 1, this novel method in greater detail is extended to include not only a notification broker 140 but also specialised indexing services (for example, Sports indexing service 122, Pictures indexing service 124, Reviews indexing service 126, News indexing service 128) that focus on specific information types of information (e.g., text 152 and picture 154) in articles such as 150 published by publisher 160.

The architectural advantages of distributed versus centralised systems are well known and accepted. Centralised indexing introduces bottlenecks both from a performance, algorithmic and management point of view. Furthermore, the publish/subscribe model introduces anonymity so that new publishers and subscribers in the form of Object Servers and Indexing Services can be added at. will without affecting the existing system. Each of the distributed indexers can be optimised to a particular form of content or style (e.g., audio, video, structured or unstructured text etc.), which would be considerably more difficult in a simple centralised configuration.

It will be understood that the novel method described herein is explicitly selective in that the subscription mechanism enables each indexing service to prescribe its area of interest, and the Broker provides a notification service and delivers only the object metadata that matches the subscription. The Broker performs a relatively neutral function: forwarding publications to interested subscribers. The Broker is aware only that some application is interested in a particular topic, not the reason why there was interest. The Broker is simply providing a notification service for indexers to access objects or indexes if necessary. The combination of anonymous publish/subscribe technology to integrate the otherwise centralised indexing and object storage allows content to be “pushed” to end user clients.

It will be appreciated that the method can be extended further to allow for the Indexing Services themselves to publish metadata. In addition to allowing content to be “pushed” to End User Clients, this metadata enables other Indexing Services to be provided at a richer semantic level. For example, the Indexing Services might include one that specializes in images and another that specializes in textual descriptions of objects. A higher-level service subscribes to the metadata published by the image and text indexing services to construct a richer index that contains semantic links between the image and the text.

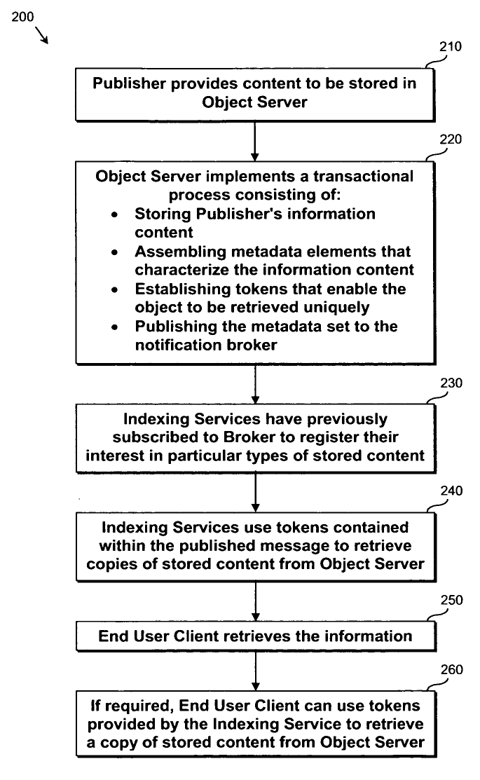

Referring now also FIG. 3, the method 200 followed in use of the novel system is as follows:
210 A Publisher such as publisher 160 has some content to be stored in an Object Server. In this case the content consists of a news article 150 containing a picture 152 and text 154. The article is formatted in some well-known standardised format, which need not be further described herein.
220 The Object Server 110 implements a transactional process that consists of the following steps:
   Storing the Publisher's information content
   Assembling the metadata elements that characterize the information content
   Establishing the tokens that enable the object to be retrieved uniquely
   Publishing the metadata set to the notification broker
230 A set of Indexing Services 122-128 have previously subscribed to the Broker 140 to register their interest in particular types of stored content. The Indexing Services each have particular specialisations which may be based on content formats (text, audio, image, video, etc.) or content domains (news, entertainment, medical, legal, etc). In this example, the News and Pictures Indexing Services (128 and 124 respectively) have subscribed to the Broker 140 to receive a copy of the published message.
240 The Indexing Services use the tokens contained within the published message to retrieve copies of the stored content from the Object Server. They can then run their specialised content indexing algorithms on the retrieved object and store the newly generated indexes in their database. These indexes provide a reference to the content stored within the Object Server.
250 An End User Client may now retrieve the information. This can be achieved in two ways:
   The End User Client may submit a query to a set of the Indexing Service(s) and retrieve the stored content. This model corresponds to the current “pull” model.
   Once an Indexing Service has created a new index, it can publish a message to the Broker stating that a new index entry is available for retrieval. End Users can subscribe to particular topics of interest and be informed that new content is available. This model is the novel “push” method).
260 The index information retrieved by the End User Client will typically contain an abstract describing the stored content. If required, the End User Client can use the tokens provided by the Indexing Service to retrieve a copy of the stored content from the Object Server.

Indexing services that are configured for higher-level semantic enrichment inspect the enhanced metadata received from the lower-level indexing services via the Broker. If the metadata is relevant to the higher-level indexing service, then the service creates an entry in its structured index. If the higher-level indexing service relies on more extensive analysis of the fresh information object, then it may use the retrieval tokens for the information object to retrieve a copy for further analysis. This method of enrichment is not restricted to a two-tier model as described in this example, but may be extended to an n-tier model with the n^{th} tier inspecting metadata from the lower n-1 tiers. Higher-level semantic indexing services will employ more complex index structures and algorithms, but the nature of these, and the means whereby index entries are created, need not be discussed herein.

It will be understood that the system and method for general notification of newly-acquired information described above provides a combination of anonymous publish/subscribe technology to integrate otherwise centralised indexing and object storage, allowing content to be “pushed” to end user clients.

1. A system for notification of acquired information, the system comprising:
means for subscribing to a broker for a predetermined selection of information stored on an object server; and
means for producing related information associated with the information stored on the object server, and publishing the related information to the broker for use in retrieval of the stored information from the object server.

2. The system according to claim 1 wherein the means for subscribing comprises means for subscribing an indexing service to a broker for a predetermined selection of information stored on an object server.

3. The system according to claim 2, wherein the related information comprises metadata.

4. The system according to claim 3, wherein the related information further comprises at least one token.

5. The system according to claim 4 wherein the indexing service is arranged to receive the metadata for indexing.

6. The system according to claim 5 wherein the indexing service is arranged to determine if the metadata is relevant to its level of indexing and accordingly to use the at least one token to retrieve a copy of the related information for further analysis.

7. The system according to any one of claim 2 wherein the indexing service is arranged to publish metadata for use in indexing by another indexing service.

8. A computer-implemented method of notification of acquired information, the method comprising:
subscribing to a broker for a predetermined selection of information stored on an object server; and
producing related information associated with the information stored on the object server, and publishing the related information to the broker for use in retrieval of the stored information from the object server.

9. The method according to claim 8 wherein the step of subscribing comprises subscribing an indexing service to a broker for a predetermined selection of information stored on an object server.

10. The method according to claim 9, wherein the related information comprises metadata.

11. The method according to claim 10, wherein the related information further comprises at least one token.

12. The method according to claim 11 wherein the indexing service is arranged to receive the metadata for indexing.

13. The method according to claim 12 wherein the indexing service is arranged to determine if the metadata is relevant to its level of indexing and accordingly to use the at least one token to retrieve a copy of the related information for further analysis.

14. The method according to any one of claim 9 wherein the indexing service publishes metadata for use in indexing by another indexing service.

15. (canceled)

16. A computer program product for notification of acquired information, the computer program product comprising computer program instructions stored on a computer readable storage medium for, when loaded on to a computer and executed, causing a computer to carry out the steps of;
subscribing to a broker for a predetermined selection of information stored on an object server; and
producing related information associated with the information stored on the object server, and publishing the related information to the broker for use in retrieval of the stored information from the object server.

17. (canceled)
